(19) United States
(12) Patent Application Publication
(10) Pub. No.: US 2003/0096041 A1
(43) Pub. Date: May 22, 2003

(54) Deep-frozen dietetic cake

(76) Inventor: Reginald Allouche, Paris (FR)

Correspondence Address: PIPER RUDNICK, P. O. BOX 64807, CHICAGO, IL, 60664-0807, US

(21) Appl. No.: 10/311,517

(22) PCT Filed: Jun. 14, 2001
(86) PCT No.: PCT/FR01/01852

(30) Foreign Application Priority Data
Jun. 14, 2000 (WO) PCT/FR00/01641

(51) Int. Cl. A23G 1/00

(52) U.S. Cl. 426/100

(57) ABSTRACT

The invention concerns a high-protein and low calorie dietetic product, in the form of a sweet or savoury cake, cooked and deep-frozen. Said deep-frozen high-protein and low-calorie cake has a protein content ranging between 15 and 25%; a carbohydrate content between 5 and 10% and a lipid content between 1 and 5%. Its water content ranges between 40 and 72% and its calorie value ranges between 120 and 200 Kcal per 100 g.

The invention relates to a dietetic product which is provided in the form of a deep-frozen baked sweet or savory cake.

This dietetic product is essentially characterized in that it is baked and deep-frozen, in that it has a high protein content and a low carbohydrate and lipid content. Generally, the calorific value of this product is between 120 and 200 Kcal/100 g.

Traditional products of the cake type are reputed to be anti-diet products because most often they have a very high lipid content and a very high content of flour which contains a high proportion of carbohydrates. The calorific value of these products is further increased when the cakes are sweetened since a high content of sucrose is added in this case. By way of example, a conventional cake formula contains about 13 g of lipids and 64 g of carbohydrates per 100 g of commercial product. Also by way of example, a quiche lorraine type product contains about 12.5 g of lipids and about 18.5 g of carbohydrates per 100 g of commercial product.

Now, consumers are increasingly aware of their physical appearance and do not wish to gain weight while at the same time continuing to enjoy eating, that is to say while eating a lot, and tasty products. They are therefore increasingly led to turn to multiple so-called “slimming” diets which are most generally characterized by a lower daily calorie intake, obtained by a lower quantity of ingested food which is most often associated with a reduction in the lipid content.

Unfortunately, these diets are difficult to adhere to over a long period and cause weight loss linked to a loss of muscle mass. A lack of skin tone and elasticity, and a physical and intellectual asthenia are then observed, and people following these diets to the letter do not eat to satiety and therefore suffer from hunger and feel frustrated.

A need therefore exists for diet products which, while being low in calories, do not cause the harmful consequences indicated above and which allow the consumer to follow a diet with pleasure, that is to say which allow him to eat to satiety and to lose his fatty mass, without this being to the detriment of his lean mass.

It would therefore be advantageous to be able to market a savory or sweet cake-type product which is high in protein and at the same time low in calories. However, this requirement of having little lipid and little carbohydrate in a product of this type, which should also have a soft and aerated structure, makes its manufacture extremely difficult.

It is therefore at the cost of long research studies that the applicant has succeeded in developing a formulation which is high in protein, low in calories and which has at the same time an acceptable texture, very satisfactory organoleptic characteristics, and which is baked homogeneously.

This product is characterized in that it contains, the percentages being expressed by weight over the commercial product, and therefore over the product obtained after baking:

a protein content (calculated in N×6.25) of between 15 and 25%, a carbohydrate content of between 5 and 10%, and a lipid content of between 1 and 5%,

preferably, a protein content of between 15 and 22%, a carbohydrate content of between 5 and 9%, and a lipid content of between 1 and 4.5%,

still more preferably, a protein content of between 15 and 21%, a carbohydrate content of between 5.5 and 9%, and a lipid content of between 1.5 and 4.5%.

The total calorific value of the product is between 120 and 200 Kcal/100 g, preferably between 120 and 180 Kcal/100 g, and still more preferably between 120 and 170 Kcal/100 g.

Its water content is, moreover, between 40 and 72%, preferably between 40 and 70%.

The cake-type product thus defined is also characterized in that its chemical score is greater than 100.

It is recalled that the expression chemical score of a protein is understood to mean the product by 100 of the smallest of the quotients obtained by dividing, for each of the essential amino acids, the quantity present in 100 g of this protein by the corresponding quantity present in 100 g of the protein serving as reference, the latter being characterized by the following contents expressed relative to 100 g:

L isoleucine: 4 g

L leucine: 7 g

L lysine: 5.5 g

DL methionine+L cystine: 3.5 g

L phenylalanine+L tyrosine: 6 g

L threonine: 4 g

L tryptophan: 1 g

L valine: 5 g

In the case where the formula proves to be deficient in amino acids, they are added in a sufficient quantity for the chemical score to be greater than 100.

The proteins used for constituting the product in accordance with the invention may be of animal or plant origin. It is preferable to use milk proteins such as total milk protein, lactalbumin, whey, milk protein concentrates containing little or no lactose, ultrafiltered milk proteins, butter milk and ultrafiltered butter milk, or heat-coagulated lactose-free serum proteins. According to a preferred embodiment of the invention, the milk proteins are present in an amount of between 9 and 18 g, preferably between 10 and 18 g, and still more preferably between 10 and 17.5 g by weight per 100 g of commercial product. It is also possible to use, besides the milk proteins, other proteins such as in particular egg, soybean, pea or lupine proteins.

As carbohydrates, it is possible to use wheat or corn flour, polydextroses or polyfructoses, maltodextrins, starches, in particular from potato. Preferably, wheat flour is used, in a quantity of between 0.5 and 6 g, preferably between 1 and 6 g, and still more preferably between 1 and 5.5 g. Likewise, potato starch is preferably used, in a quantity of between 0.25 and 4 g, preferably between 0.25 and 3.75 g, and more preferably between 0.25 and 3.5 g, per 100 g of commercial product.

As lipids, it is possible to use in particular cheese powders. It is possible to optionally incorporate powders of plant or animal fat.

The deep-frozen product in accordance with the invention preferably contains, per 100 g of commercial product, between 2 and 8 g of egg white powder, preferably between 2.5 and 8 g, and more preferably between 3 and 8 g.

It contains, in addition, according to a preferred embodiment, the quantities also being indicated per 100 g of commercial product:

from 0.2 to 1.5 g, preferably from 0.25 to 1.25 g, and still more preferably from 0.25 to 1.12 g of leavening powder, in the form, for example, of sodium bicarbonate and sodium pyrophosphate, or of baker's or brewery yeast,

from 0.01 to 0.15 g, preferably from 0.01 to 0.12 g, and still more preferably from 0.02 to 0.12 g of thickeners, such as xanthan, carob and carragheenan gums, and the like.

Of course, the deep-frozen cake in accordance with the invention may contain other conventional ingredients such as flavorings, vegetable or fruit powders, amino acids, spices, taste enhancers, intense sweeteners, soluble or insoluble fibers, powdered and/or liquid and/or lump flavour markers.

A typical high-protein and high-calorie cake formulation according to the invention is the following:

proteins (N×6.25): 15 to 20%

carbohydrates: 5 to 6%

lipids: 3 to 4%

calorific value less than 150 Kcal per 100 g of commercial product.

The invention also relates to the method for preparing the deep-frozen product in accordance with the invention, this method comprising the following steps:

selecting the ingredients, weighing and measuring out, said ingredients being for the majority in powder form,

mixing a portion of the overrun-producing or foaming agents, and a portion or the whole of the thickeners, and then hydrating,

giving the mixture thus obtained a degree of over-run,

mixing and hydrating the other ingredients, which are, for the majority, provided in powdered form, most generally at the rate of 100 g of powder per 0.12 to 0.16 liter, in order to obtain a pastry,

incorporation of the mixture having a degree of overrun with the pastry, generally at the rate of 100 g of mixture having a degree of overrun per 350 to 420 g of pastry,

individual measuring out into dishes,

allowing the pastry to rest, for a period of between 15 minutes and 60 minutes, preferably between 20 minutes and 50 minutes, and still more preferably for a period of close to 30 minutes,

static baking in constant saturated steam in order to obtain a temperature of about 70 to 85° C., and preferably of about 75° C., in the center of the product,

cooling,

infrared browning for a period of 30 seconds to 90 seconds, preferably of the order of 60 seconds,

packaging and deep-freezing.

The invention will be understood more clearly with the aid of the following embodiment which is given purely by way of illustration.

### EXAMPLE

### Preparation of a Cheesecake

A high protein and low calorie pastry was prepared and then measured out into aluminum dishes, at the rate of 110 g for each dish, the aim being to obtain, after baking, a small solid cheesecake of 110 g.

The composition was the following:

Basic powder mixture:

| Ingredients | % |
|---|---|
| Cheese flavor | 2.69 |
| Sodium bicarbonate | 0.93 |
| Sodium pyrophosphate | 1.41 |
| Salt | 1.40 |
| Inulin RAFTILINE GR | 4.86 |
| Potato starch PREGEFLO PJ 30 | 2.70 |
| Whole millstone flour | 7.66 |
| Lauriou | |
| Milk proteins PL 80 | 21.61 |
| (Triballat) | |
| Milk proteins WPC 90 | 21.61 |
| (Triballat) | |
| Emmenthal cheese type 5 | 27.01 |
| (Proseca) | |
| Egg white powder HG | 8.12 |
| (Igreca) | |
| TOTAL | 100 |

Egg white powder mixture:

| Ingredients | % |
|---|---|
| Egg white powder HG | 97.656 |
| (Igreca) | |
| Xanthan gum RHODIGEL | 2.344 |
| (Rhodia) | |
| TOTAL | 100 |

Method:

66 g of egg white powder mixture are weighed and 445 ml of cold water are added thereto before beating this preparation until stiff.

794 g of basic powder mixture are weighed and 1.18 l of cold water are added thereto. This is mixed until a lump-free pastry is obtained.

This pastry is then continuously mixed with the egg white beaten until stiff.

Measuring out into dishes of 110 g and then baking and browning are then carried out.

Baking:

Various baking trials were carried out on industrial equipment.

1st Baking Trial

The baking was carried out in a traditional manner at 180° C., without controlling the moisture. Despite experimenting with several baking times, it was never possible to obtain homogeneous baking of the pastry in the dish.

The rapid formation of an elastic crust at the surface is observed, and then this crust hardens and cooks but prevents the pastry from cooking inside, the latter therefore remaining liquid.

On increasing the baking time, the crust burns, but the pastry inside is still not cooked.

Furthermore, with this traditional mode of baking, dehydration of the pastry is observed. Thus, with a measuring out of 110 g of pastry per dish, about 80 g of product are recovered after baking.

This mode of baking is therefore not satisfactory.

2nd Baking Trial

The baking took place with regular injection of steam. Due to baking at a lower temperature, this allows less attack on the high protein and low calorie pastry.

During baking, the pastry rises in the dish, like a soufflé. Inside, the pastry has risen, has cells of about 2 to 3 mm but it is not baked. Outside, the pastry also forms a crust. At the end of baking, the cake collapses, demonstrating that the inner pastry is not properly baked.

This trial shows nevertheless that it is necessary for the baking to take place in the presence of steam. However, with the injection of steam, although the high protein pastry increases in volume during baking, on the other hand, the presence of the crust indicates a lack of moisture and an excessively high baking temperature.

3rd Baking Trial

The baking this time takes place in constant saturated steam, at lower temperature, so as to obtain a temperature of about 75° C. in the center of the cake. This baking method is equivalent to baking in a static humidity proof box.

The baking takes 20 minutes, the temperature in the oven rises to about 95° C. and the temperature in the center of the cake rises to 70-85° C.

The result obtained is satisfactory: uniform baking of the cake is observed, the cells of the pastry are cooked and there is no crust at the surface.

Depending on the pastry rest time before baking, the cake appears differently:

if no rest is observed between the measuring out of the pastry into the dishes and the baking, the cake bakes but sticks to the edge of the dish.

The presentation is therefore not esthetic and it is very difficult for the consumer to unmold the cake.

If a rest of about 30 minutes is observed between the measuring out into dishes and the baking, the cake shrinks slightly such that it does not adhere to the edge of the dish. Its appearance is much more satisfactory.

It is this rest time which is therefore considered, under these conditions, as being optimal.

On coming out of the oven, the products are allowed to cool to room temperature for about 20 minutes, after which the products are browned.

Browning:

Browning Trial No. 1

The baking in saturated steam does not color the product: the latter therefore has a cream color on leaving the step of baking in saturated steam. Trials for browning the cake on the surface are therefore carried out.

Browning trials were first of all carried out using direct flame (gas supply), by regulating the distance of the flame from the cake, so as not to burn the aluminum dish and not to burn the top of the cake.

These trials lead nevertheless to browning which is black in color and not brown-yellow, which is not acceptable.

Browning Trial No. 2

An infrared browning apparatus is used, the apparatus emission temperature being about 1000° C.

The distance of the product with respect to the browning grill is an important parameter: a distance of 15 cm does not lead to satisfactory browning. It is at a distance of about 12.5 cm that browning occurs.

Likewise, the browning time is involved for the production of a product having a regular appearance, without craters and having a smooth surface.

A time of one minute appears to be the optimum time: there is no crust and the color is golden without being brown. During the first 50 seconds, there is no apparent browning, but bubbles appear at the surface. Between 50 seconds and 60 seconds, browning occurs rapidly and a high protein and a low calorie cake is finally obtained which has a completely satisfactory appearance and texture, and which has excellent organoleptic properties.

1. A deep-frozen baked cake, having a protein content (calculated in N×6.25) of between 15 and 25%, a carbohydrate content of between 5 and 10%, a lipid content of between 1 and 5%, and a water content of 40 to 72%, these percentages being expressed by weight relative to the commercial product.

2. The deep-frozen baked cake as claimed in claim 1, having a protein content of between 15 and 22%, a carbohydrate content of between 5 and 9%, and a lipid content of between 1 and 4.5%.

3. The deep-frozen baked cake as claimed in either of claims 1 and 2, having a protein content of between 15 and 21%, a carbohydrate content of between 5.5 and 9%, and a lipid content of between 1.5 and 4.5%.

4. The deep-frozen baked cake as claimed in any one of claims 1 to 3, characterized in that its water content of between 40 and 70%.

5. The deep-frozen baked cake as claimed in any one of claims 1 to 4, characterized in that it has a chemical score greater than 100.

6. The deep-frozen baked cake as claimed in any one of claims 1 to 5, characterized in that it has a total calorific value between 120 and 200 Kcal per 100 g, preferably between 120 and 180 Kcal per 100 g, and still more preferably between 120 and 170 Kcal per 100 g.

7. The deep-frozen baked cake as claimed in any one of claims 1 to 6, characterized in that it has a wheat flour content of between 0.5 and 6 g, preferably between 1 and 6 g, and still more preferably between 1 and 5.5 g, per 100 g of commercial product.

8. The deep-frozen baked cake as claimed in any one of claims 1 to 7, characterized in that it has a potato starch content of between 0.25 and 4 g, preferably between 0.25 and 3.75 g, and still more preferably between 0.25 and 3.5 g, per 100 g of commercial product.

9. The deep-frozen baked cake as claimed in any one of claims 1 to 8, characterized in that it comprises from 9 to 18%, preferably from 10 to 18%, and still more preferably from 10 to 17.5% of milk proteins, the percentages being expressed by weight relative to the commercial product.

10. The deep-frozen baked cake as claimed in any one of claims 1 to 9, characterized in that it comprises an overrun-producing or foaming agent consisting of whole egg or egg white powder, this foaming agent being in a quantity of 2 to 8%, preferably 2.5 to 8%, and still more preferably 3 to 8%.

11. The deep-frozen baked cake as claimed in any one of claims 1 to 10, characterized in that it contains a leavening agent, in a quantity between 0.2 and 1.5%, preferably between 0.25 and 1.25%, and still more preferably between 0.25 and 1.12%, said leavening agent being preferably selected from the group consisting of traditional leavening agents such as baker's or brewery yeast, sodium bicarbonate or sodium pyrophosphate.

12. The deep-frozen baked cake as claimed in any one of claims 1 to 11, characterized in that it contains from 0.01 to 0.15%, preferably from 0.01 to 0.12%, and still more preferably from 0.02 to 0.12 g of thickener, preferably consisting of xanthan, carob or carragheenan gums.

13. The deep-frozen baked cake as claimed in any one of claims 1 to 12, having a protein content of 15 to 20%, a carbohydrate content of 5 to 6%, a lipid content of 3 to 4%, and a calorific value of less than 150 Kcal per 100 g of commercial product.

14. A method for preparing a deep-frozen baked cake as claimed in any one of claims 1 to 13, characterized in that it comprises the following steps:
selecting the ingredients, weighing and measuring out, said ingredients being for the majority in powder form,
mixing a portion of the overrun-producing or foaming agents, and a portion or the whole of the thickener, and then hydrating,
giving the mixture thus obtained a degree of over-run,
mixing and hydrating the other ingredients, which are, for the majority, provided in powdered form, particularly at the rate of 100 g of powder per 0.12 to 0.16 liter, in order to obtain a pastry,
incorporation, particularly at the rate of 100 g of mixture having a degree of overrun per 350 to 420 g of pastry,
individual measuring out into dishes,
allowing the pastry to rest, for a period of between 15 minutes and 60 minutes, preferably between 20 minutes and 50 minutes, and still more preferably for a period of close to 30 minutes,
baking in constant saturated steam in order to obtain a temperature of about 70 to 85° C., and preferably of about 75° C., in the center of the product,
cooling,
infrared browning for a period of 30 seconds to 90 seconds, preferably of the order of 60 seconds,
packaging and deep-freezing.
